(19) United States
(12) Patent Application Publication
(10) Pub. No.: US 2013/0297342 A1
(43) Pub. Date: Nov. 7, 2013

(54) COMPUTER-BASED SYSTEM FOR MANAGING A PATIENT SUPPORT AND INFORMATION NETWORK

(71) Applicant: HEALTHEO360, Flemington, NJ (US)

(72) Inventor: David S. Duplay, Flemington, NJ (US)

(73) Assignee: Healtheo360, Flemington, NJ (US)

(21) Appl. No.: 13/854,414

(22) Filed: Apr. 1, 2013

Related U.S. Application Data
(60) Provisional application No. 61/643,556, filed on May 7, 2012.

(51) Int. Cl. G06F 19/00; G06Q 50/24

(52) U.S. Cl. CPC G06F 19/322; G06Q 50/24
USPC 705/3

(57) ABSTRACT

System in support of managing patient support for patients suffering from various ailments includes a computer, a processor, a memory and a display. A user interface receives patient support information and enables navigation. Modules execute to configure the processor in certain ways, including a patient profile module which defines a custom patient profile which includes personal factors that relate to at least one ailment, a patient similarity module which processes and organizes the patient profiles within ailment classes by weighing the personal factors and calculating a degree of a similarity between the patient profile and other patient profiles within the same ailment class. A first content module provides an output to users in which content is displayed in order of a similarity between the patient profile and the other patient profiles in the same ailment class. Further modules can be provided to track content-viewing tendencies and assess users' ailment concerns.

This application claims the benefit of priority from U.S. Provisional Application Ser. No. 61/643,556, filed on May 7, 2012, entitled “Computer-Based System for Managing a Patient Support and Information Network,” which is hereby incorporated by reference as if set forth in its entirety herein.

### FIELD OF THE INVENTION

The present invention relates to the field of social networking. More particularly, the present invention relates to building a social network for patients of various ailments. As such, the present invention provides an on-line platform where patients can come together and receive content that are most helpful to their medical situation.

### BACKGROUND OF THE INVENTION

The continued growth of the Internet and social networking has greatly expanded the capabilities and ease of providing and consuming information. It has become common to share, search and rely on a variety of information over the Internet. Patients often have the information needs to understand the particular aspects of their situation, thus are a special group among all the Internet users. In addition, to an individual patient, information and support from Internet users that suffer from similar ailments are likely most valuable. As such, medical information, relating to ailment, treatment, recovery and other associated concerns, is of one kind which value is individual-specific. However, the existing medical information available over the Internet is unorganized, and difficult to be searched and relied on by an individual patient.

Accordingly, it is desirable to be able to build a social network to maximize the information value by grouping a patient with other patients of similar conditions. Besides allowing patients to connect with each other and share medical information, it is also desirable to be able to proactively supply users with customized information relating to the ailment they suffer from. This way, users can be benefitted from the support and information received from the network in the process of recovery.

### SUMMARY OF THE INVENTION

In accordance with one aspect of the invention, a computer-based system for managing a patient support and information network is provided for patients suffering from various ailments. The system includes a computer having a processor, a memory, a user interface, and a display. The user interface is configured to receive input from a user and enable navigation through the network. For instance, the user input can include patient support information which is storable in the memory and which is displayable on command to the user through the user interface. A patient profile module executes in the processor and configures the processor to define a custom patient profile using the user interface. The patient profile can be stored in the memory, and includes personal factors that relate to at least one ailment from which the user suffers. A patient similarity module executes in the processor and configures the processor to process the stored patient profiles based on the at least one ailment. The patient similarity module further configures the processor to organize the patient profile within each ailment class by weighing the personal factors in the patient profile and by calculating a degree of a similarity between the patient profile and other patient profiles within the same ailment class based on the personal factors of the users. A first content module executes in the processor and configures the processor to output the information inputted by the other users as content and to display the content on the display in an order of degree of similarity between patient profile and the other patient profiles in the same ailment class.

In accordance with a further aspect of the invention, a computer-based system as described above can further include an ailment concern module which executes in the processor and which configures the processor to track a user's content-viewing tendency in the network and to assess the user's ailment concerns reflected by the content-viewing tendency. Such a system in accordance with this further aspect can include (a) a second content module which executes in the processor and which configures the processor to match the content stored in the memory with the user's ailment concerns assessed by the ailment concern module and output content that provides support information of such concerns, and (b) a content organization module that allows the user to rate the content supplied by the first and second content modules.

These and other aspects, features and advantages of the invention can be appreciated from the accompanying description of certain embodiments of the invention which are provided to enable the invention as claimed, and are in no way to be construed as limiting the invention beyond the recitations in the claims and equivalents covered thereby.

### BRIEF DESCRIPTION OF THE DRAWING FIGURES

FIG. 1 is an exemplary computing system environment that can be used in an embodiment of the invention.

FIG. 2 is an example of the user interface that can be used in an embodiment of the invention.

FIG. 3 illustrates a different part of the user interface than shown in FIG. 2, in which content is displayed and navigation controls are provided, as can be used in an embodiment of the invention.

FIG. 4 illustrates a different part of the user interface than shown in FIGS. 2 and 3, in which logged-in users manage their account through the user interface, as can be used in an embodiment of the invention.

FIG. 5 is another part of the user interface of FIG. 4, as can be used in an embodiment of the invention, now showing data capture that is used in connection with the analysis and processing of content described more fully hereinbelow.

### DESCRIPTION OF CERTAIN EMBODIMENTS OF THE INVENTION

By way of overview and introduction, the invention described herein concerns a computer-based system for managing a patient support and information network. The system is directed to assisting users suffering ailments to share and connect with patients of similar conditions. The system is further directed to proactively supply information to a user that is relevant to his ailment or concern. Through the system, users are able to better manage their conditions and foresee other aspects of recovery.

It is to be appreciated that the embodiments of this invention as discussed herein may be incorporated as a software algorithm, application, program or code residing in hardware, firmware and/or on a computer useable medium (including software modules and browser plug-ins) that can be executed in a processor of a computer system to configure the processor to perform the functions described below. Such a computer system typically includes memory storage configured to provide output from execution of the computer algorithm, code, or program. The processor may be configured to execute one or more modules.

The computer system preferably includes a processor (such as a digital data processor), a memory, and a control circuit. The memory stores data and instructions suitable for controlling the operation of processor. An implementation of memory can include, for example, a random access memory (RAM), a hard drive and a read only memory (ROM), or any of these components.

One of the components stored in memory is a program. Program includes instructions for controlling processor to perform particular tasks or implement particular abstract data types. Program may be implemented as a plurality of modules that operate in cooperation with one another. Program is contemplated as representing a software embodiment, or a component or module thereof, of the method described herein.

In embodiments of the present invention, portions of the program including selected modules or code thereof can execute entirely without user input or other commands based on programmatic or automated access to a data signal flow through other systems that may or may not require a user interface for other reasons.

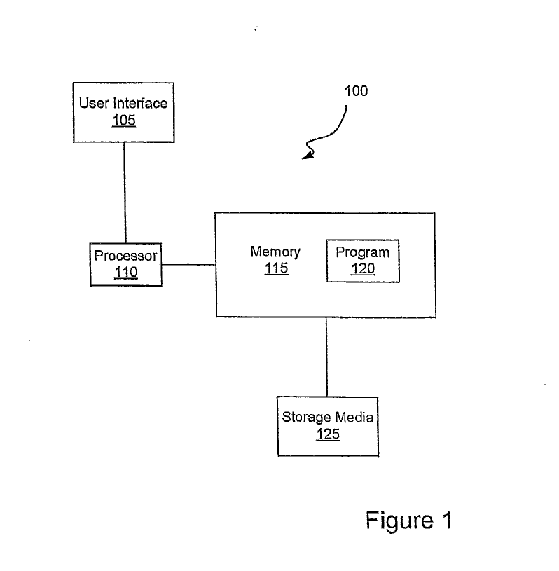

With the exemplary computing system environment of FIG. 1 being generally shown and discussed above, the system of the invention in accordance with illustrated embodiments are also discussed herein.

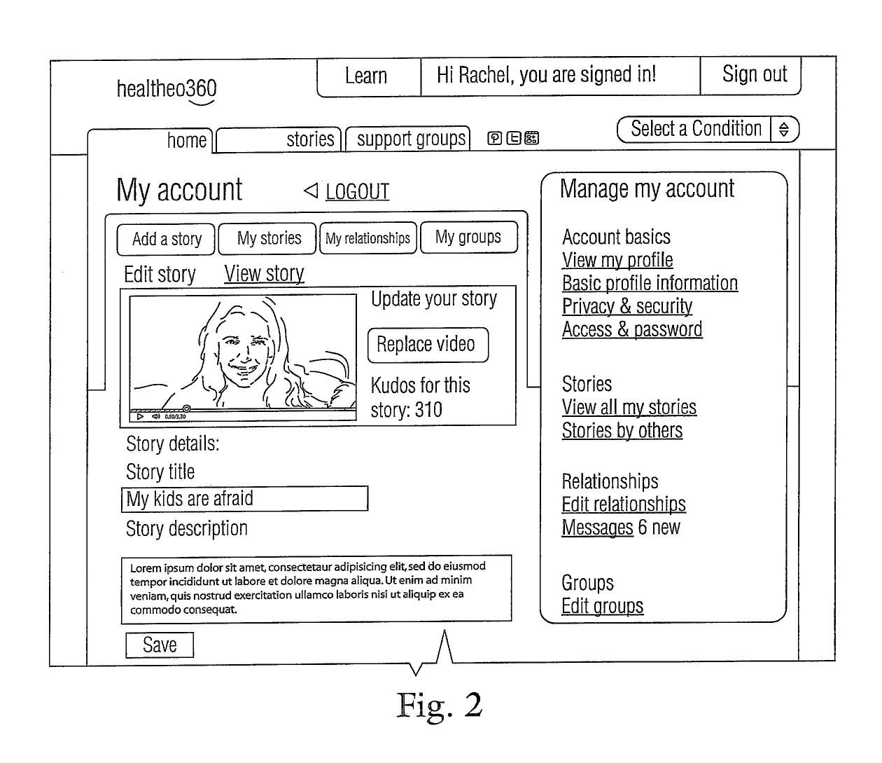

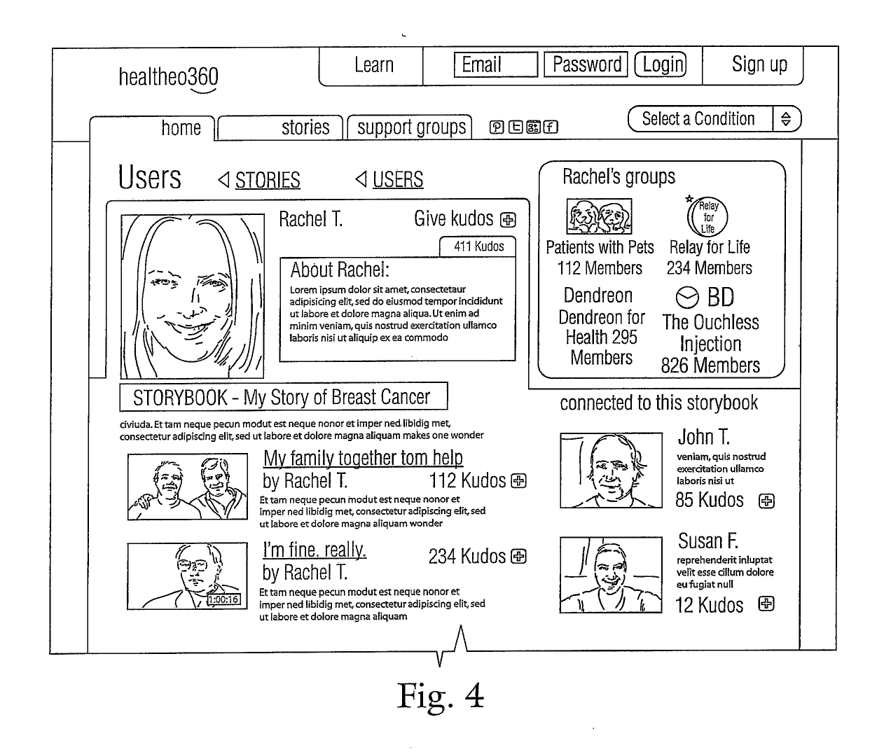

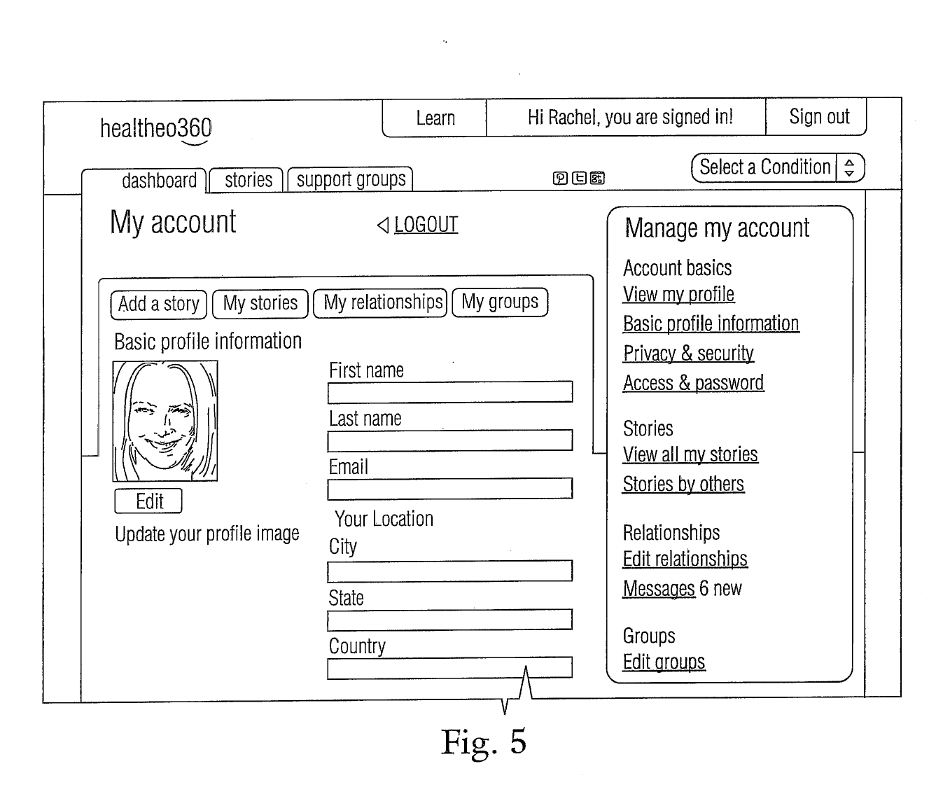

In one embodiment, the user interface can comprise a plurality of interactive pages that are delivered on demand to users seated at devices connectable to various computer networks such as the Internet. Users interact with the pages using devices having a processor, memory , a network interface card (NIC), and navigation software such as a web browser program. Preferably, the pages that comprise the user interface are compatible with one or more conventional web browsers. FIGS. 2 through 5 illustrate examples of pages in accordance with the illustrated embodiment of the invention that can be rendered in conventional browsers used by any number of users. The users input information and command selections to the processor of their respective devices and such information and commands are provided to the system of the present invention (e.g., a server which is a computer having at least one processor and memory or access to memory) for processing and delivery of further information.

A set of modules cooperate with one another to provide the information presented through the interface. It is possible to envision to all of the disclosed features and capabilities of the present invention as software modules. These modules are stored as computer code in memory and are executed by the processor. The modules described hereunder include a patient profile module, a patient similarity module, a first content module, an ailment concern module, a second content module and a content organization module that are executed by processor.

The system also includes an output device such as a display, a touch screen or a data terminal. In the case of a touch screen, the input and output functions are provided by the same structure.

FIG. 2 is an example of the user interface. In one aspect, the user interface is configured to provide access to various information input and editing functions enabled for a user. In another words, a user of the system can input information through the user interface. The information a user can input include information identifying the user, content submitted by the user, and other information.

The content submitted by the user can take various forms, including text, images and videos, or any combination thereof. The exemplary user interface also allows the user to upload videos and images. The content submitted by the user through the user interface is transmitted by the processor and stored in the memory in association with that individual user.

An exemplary user interface is similar to Microsoft Word where a user can edit, delete, copy and paste text to create content. In several embodiments, a user can input information regarding ailment, treatment, recovery, or other associated concerns. Examples of such content include, but are not limited to:
Feelings after diagnosis—emotional (how to discuss the illness with family, friends, and work colleagues), what can be expected in the early days post diagnosis, what have others done as they began searching for a treatment plan, how to maintain a positive outlook
Disease progression—what might happen as the disease progresses and what the patient might expect
Tips and suggestions on how to live with the condition
Tips and suggestions on overcoming fears
Lifestyle change requirements and how to make the best of each situation
Support group information for patients and caregivers
Local directories of support groups and other qualified facilities or groups
Clinical trial information—when, where and qualifications

The user is presented with editing tools in the user interface. A user can modify previously inputted content through the user interface by the editing tools executed by the processor. The editing tools enable a user to view a list of the content associated with that user. Upon the user's command on the editing tools, the information to be edited is retrieved from the memory and displayed at the user interface. The user may preview the changes, save and/or discard the changes. The edited content is stored in the memory in association with that individual user.

In one aspect, a user inputs his personal factors through the user interface to create a patient profile. The creation and management of information identifying a user is configured by the patient profile module as described below. In one aspect, a user can determine whether the particular inputted information is accessible by other users.

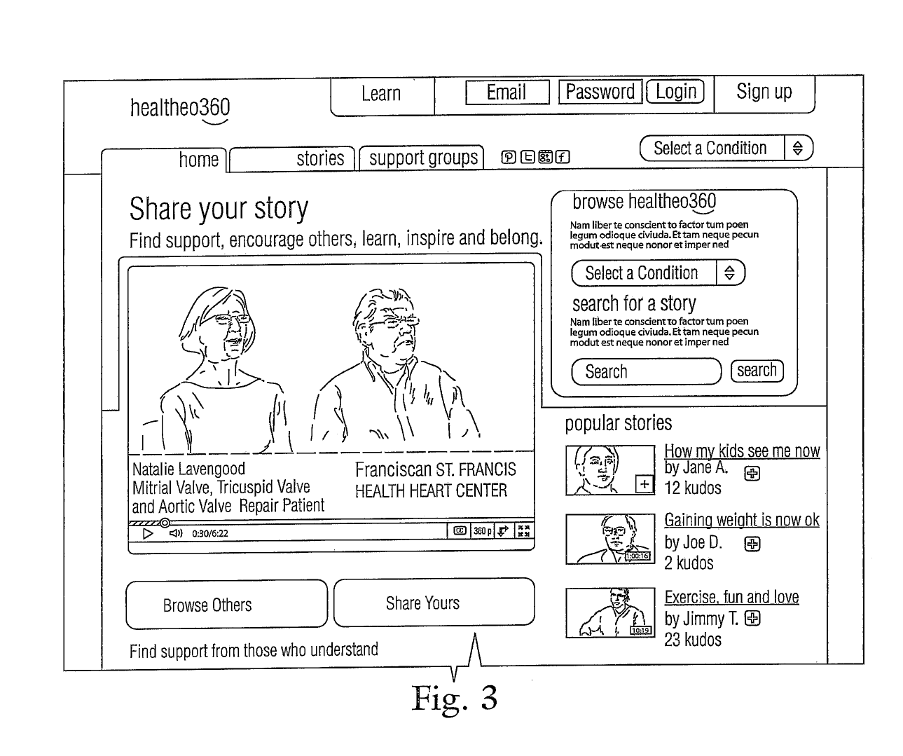

FIG. 3 illustrates an exemplary user interface for displaying and navigating content through the user interface. hi one aspect, each content module described below is selectable by a user to access a preview of the content that is displayed within content module. Additionally, the preview may further provide access to the additional content, which may open or launch a new window or application to access the additional content.

As described, the content modules may be associated with different types of content such as text, images and videos, combinations thereof, and any other content suitably displayed on the user interface.

The patient profile module is configured to manage patient profiles associated with users of the system. The patient profile module executes in the processor and configures the processor to define a patient profile. The patient profile module enables a user to input and modify the information in the user profile through the user interface.

A user profile contains basic individual information of a user such as: first name, last name, email address, user name, the creation of a password, geography location (city and state), and a short description about their ailments. The information contained in a user profile is also modifiable through the user interface.

Preferably, the ailments information inputted by a use includes the ailment(s) the individual suffers, as well as the associated degree of severity, treatment plans, and degree of recovery.

In one aspect, a user can select the class of ailment that his conditions fall under. Applicable aliment classes include but are not limited to: Asthma, Blood Cancer, Breast Cancer, Cardiovascular Disease, Colon Cancer, COPD, Diabetes Type 1, Diabetes Type 2, High Cholesterol, High Triglycerides, Hip Replacement, Hypertension, Knee Replacement, Lou Gehrig's Disease, Multiple Myeloma, Osteo Arthritis, Pain Management, Parkinson's Disease, Prostate Cancer, Rheumatoid Arthritis, Skin Cancer, Testicular Cancer.

A patient similarity module is configured to assemble patient profiles, and to further assess similarities of users of the system based on the information contained in the patient profiles.

In one embodiment, the patient similarity module executes in the processor and configures the processor to process stored user profiles in the memory. Specifically, the module configures the processor to organize patient profiles on the network based on the ailment class indicated in their profile. As such, users who indicate that they suffer a same class of ailment are grouped.

Preferably, if a user selected more than one ailment class in the patient profile, the patient similarity module configures the processor to process the patient profile each time his ailment class is grouped.

The patient similarity module further configures the processor to organize the patient profiles within each ailment class by weighing the personal factors of the users. Such personal factors include age, sex, geography, degree of severity and degree of recovery. According to the weight assigned to each personal factor, the patient similarity module calculates a degree of similarity between a particular patient profile and other patient profiles within the same ailment. In a preferred embodiment, the personal factors of degree of severity and/or degree of recovery must be weighed in to calculate the degree of similarity among the users of the same ailment class. The calculated degree of similarity is stored in the memory in association with the individual user.

A first content module is configured to supply content to a user based on the associated degree of similarity for that individual user in his ailment class. Specifically, a first content module retrieves the stored content submitted by the other users in the same ailment class from the memory. The first content module further organizes the retrieved content in the order of the degree of similarity between a particular patient profile and the other patient profiles in the same ailment class.

For example, in the ailment class of asthma, there are four (4) users. User A, User B and User C all suffer from stage 1 asthma. User D nevertheless suffers from stage 4 asthma. Under the calculation of the patient similarity module for User A, User B and User C would score a higher degree of similarity to User A than User D. Moreover, User B will score an even higher degree of similarity than User C if User B is of the same age group as User A, but User C isn't. Thus, when the first content module is configured to output content from similar users for User A in his ailment class, the content created by User B will be displayed on the highest hierarchy level, followed by content created by User C and User D.

The content assembled by the first content module for individual user is accessible in the user interface. Specifically, the content is displayable to the user on the display device upon selection in the user interface.

The ailment concern module is configured to track a user's content-viewing tendency in the network and to assess the user's ailment concerns. In one aspect, the ailment concern module configures the processor to track indicators that reflect the content-viewing tendency at least in conjunction with the ailment from such the user suffers.

Indicators that are relevant and to be tracked by the ailment concern module include but are not limited to the dwell time on a webpage and the frequency of clicks on particular hyperlinks.

Preferably, a set of ailment concerns are pre-determined and stored in the ailment concern module for each ailment class grouped in the system. After collecting sufficient amount of data regarding the content-viewing tendency for an individual user, the ailment concern module determines the score of each ailment concern for the user. The module further configures the processor to generate a hierarchy of aliment concerns for that user based on the score of the ailment concern for the user. The hierarchy of aliment concerns is stored in the memory in association with the individual user.

A second content module is configured to cause more relevant information to be displayed to the user. The second content module executes the processor to match the content in memory with the user's ailment concerns determined by the ailment concern module and outputs such content. Preferably, the matching content is outputted in the hierarchy of ailment concerns determined for that individual user and stored in the ailment concern module.

The content matched by and stored in the second content module for an individual user is accessible in the user interface. Specifically, the content is displayable to the user on the display device upon selection in the user interface.

For example, for users who are grouped in the ailment class of breast cancers, the ailment concern module executes the processor to track the content-viewing tendency indicators and determine if a user has the following specific ailment concerns associated with breast cancer:
Newly Diagnosed
Daily Care Routines
Diet & Exercise
Communicating with Family & Friends
Husbands' Network
Chemotherapy
Treatment Regimens
Mastectomy
Therapy & Support Groups

After the ailment concern module records a high clicking record and/or a long dwell time for content related to Daily Care Routines for an individual user, the second content module searches and matches the content related to Daily Care Routines stored in the memory, and outputs the matching content for that user.

By way of further example, for users who are grouped in the ailment class of diabetes, the ailment concern module configures the processor to track the content-viewing tendency indicators and determine if a user has the following ailment concerns associated with diabetes.
Newly Diagnosed
Daily Care Routines
Diet & Exercise
Healthy Habits
Communicating with Family & Friends
Blood Sugar Testing
Treatment Regimens
Therapy & Support Groups

After recording a user has a high clicking rate and/or a long dwell time for content related to several ailment concerns, including Daily Care Routines, Diet & Exercise and Blood Sugar Testing, the ailment concern module generates a hierarchy of aliment concerns according to the recorded content-viewing tendency for each concern. The second content module further configures the processor to search and match the content related to Daily Care Routines, Diet & Exercise and Blood Sugar Testing in the memory, and outputs the matching content in the hierarchy of ailment concerns determined for that user.

Through the user interface, a user receives ailment-related content from various sources, including but are not limited to the content created by other patients on the network and supplied by the first and the second content module. A display module is configured to display the content upon the command of the user.

A content organization module is configured to organize the content according to a user's preference. For example, a user can rate the content supplied by the first and second content modules in the user interface. Specifically, the user can change the hierarchy of the content by moving up and down of a specific piece of content. The user can also remove a specific piece of content from his user interface. After the content removal is effectuated, the content organization module configures the processor to match the content stored in the memory with the content that is removed by the user. Accordingly, whenever the first and second content modules are configured to generate content for that user, the content organization module filters out the content that is matched with the removed content. As such, the user may no longer view the content which he is not preferred.

The present invention is described more fully with reference to the accompanying drawings, in which one or more illustrated embodiments of the invention are shown. The invention is not limited in any way to the illustrated embodiments as the illustrated embodiments described herein are merely exemplary of the invention, which can be embodied in various forms, as appreciated by one skilled in the art. Therefore, it is to be understood that any structural and functional details disclosed herein are not to be interpreted as limiting the invention, but rather are provided as a representative embodiment for teaching one skilled in the art one or more ways to implement the invention. Furthermore, the terms and phrases used herein are not intended to be limiting, but rather are to provide an understandable description of the invention.

Although illustrated embodiments of the present invention have been described, it should be understood that various changes, substitutions, and alterations can be made by one of ordinary skill in the art without departing from the scope of the present invention. The present invention is intended to embrace all such alternatives, modifications and variances that fall within the scope of the appended claims.

While the invention has been particularly shown and described with reference to a preferred embodiment thereof, it will be understood by those skilled in the art that various changes in form and details may be made therein without departing from the spirit and scope of the invention.

What is claimed is:

1. A computer-based system for managing a patient support and information network for patients suffering from various ailments comprising:
a computer system having a processor and a memory;
a user interface configured to receive input from a user and enable navigation through the network, the user input including patient support information storable in the memory and displayable on command to the user;
a patient profile module executing in the processor and configuring the processor to define a custom patient profile using the user interface, the patient profile being stored in the memory, wherein the patient profile includes personal factors that relate to at least one ailment from which the user suffers;
a patient similarity module executing in the processor and configuring the processor to process the stored patient profiles based on the at least one ailment, the patient similarity module further configuring the processor to organize the patient profile within each ailment class by weighing the personal factors in the patient profile and calculating a degree of a similarity between the patient profile and other patient profiles within the same ailment class based on the personal factors of the users;
a first content module executing in the processor and configuring the processor to output the information inputted by the other users as content and display the content in an order of degree of similarity between patient profile and the other patient profiles in the same ailment class; and
a display for displaying the output content.

2. The computer-based system of claim 1 further comprising:
an ailment concern module executing in the processor and configuring the processor to track a user's content-viewing tendency in the network and assess the user's ailment concerns reflected by the content-viewing tendency;
a second content module executing in the processor and configuring the processor to match the content stored in the memory with the user's ailment concerns assessed by the ailment concern module and output content that provides support information of such concerns; and
a content organization module that allows the user to rate the content supplied by the first and second content modules.

3. The computer-based system of claim 2, wherein the personal factors include at least two of age, sex, geography, degree of severity and degree of recovery.

4. The computer-based system of claim 3, wherein the personal factors at least includes degree of severity and degree of recovery.

5. The computer-based system of claim 2, wherein the viewing patterns include a dwell time on a webpage.

6. The computer-based system of claim 2, wherein the viewing patterns include a frequency of clicks on particular hyperlinks.

7. The computer-based system of claim 2, wherein the content organization module is further configured to permit the user to remove the content supplied by the first and second content module.

8. The computer-based system of claim 5, wherein the first and second content module is further configured to filter information that is associated with the content that has been removed by the user.

9. The computer-based system of claim 1, wherein the personal factors include at least two of age, sex, geography, degree of severity and degree of recovery.

10. The computer-based system of claim 9, wherein the personal factors at least includes degree of severity and degree of recovery.

11. The computer-based system of claim 1, wherein the viewing patterns include a dwell time on a webpage.

12. The computer-based system of claim 1, wherein the viewing patterns include a frequency of clicks on particular hyperlinks.

13. The computer-based system of claim 1, wherein the content organization module is further configured to permit the user to remove the content supplied by the first and second content module.

14. The computer-based system of claim 13, wherein the first and second content module is further configured to filter information that is associated with the content that has been removed by the user.
